(19) United States
(12) Patent Application Publication
(10) Pub. No.: US 2015/0005951 A1
(43) Pub. Date: Jan. 1, 2015

(54) FLOORING SENSORS FOR OCCUPANT DETECTION

(71) Applicants: Venkatesh Srinivasan, Sunnyvale, CA (US); Tanuj Mohan, Mountain View, CA (US)

(72) Inventors: Venkatesh Srinivasan, Sunnyvale, CA (US); Tanuj Mohan, Mountain View, CA (US)

(73) Assignee: enLighted, Inc., Sunnyvale, CA (US)

(21) Appl. No.: 14/317,127

(22) Filed: Jun. 27, 2014

Related U.S. Application Data
(63) Continuation-in-part of application No. 14/135,814, filed on Dec. 20, 2013.
(60) Provisional application No. 61/841,392, filed on Jun. 30, 2013.

(51) Int. Cl. G05B 15/02

(52) U.S. Cl. CPC G05B 15/02
USPC 700/275

(57) ABSTRACT

Apparatuses, methods and systems for occupant sensing are disclosed. One embodiment includes an occupant sensing apparatus. The occupant sensing apparatus includes at least a portion of flooring structure, and one or more sensors associated with the at least the portion of flooring structure, wherein the one or more sensors sense a user. Further, a controller interfaced with the one or more sensor is operative to detect patterns of the user. Another embodiment includes an occupant sensing apparatus. The occupant sensing apparatus includes at least a portion of flooring structure, one or more sensors associated with the at least a portion of flooring structure, wherein the one or more sensors sense a user, and a transceiver associated with the at least a portion of flooring structure, wherein the transceiver is operative to communicate with a mobile device of the user.

### RELATED APPLICATIONS

This patent application claims priority to U.S. Provisional Patent Application Ser. No. 61/841,392, filed Jun. 30, 2103, and is a continuation-in-part (CIP) of U.S. patent application Ser. No. 14/135,814, filed Dec. 20, 2013, both of which are herein incorporated by reference.

### FIELD OF THE EMBODIMENTS

The described embodiments relate generally to building controls. More particularly, the described embodiments relate to flooring sensor for occupant detection.

### BACKGROUND

Intelligent lighting and environmental control systems reduce power consumption of lighting and environmental control while improving the experience of occupants of structures that utilize the lighting and environmental control systems. A factor utilized in controlling the systems is determination of occupancy. Further, the number of occupants can be used for controlling the systems.

It is desirable to have a method, system and apparatus for occupancy detection of an area.

### SUMMARY

One embodiment includes an occupant sensing apparatus. The occupant sensing apparatus includes at least a portion of flooring structure, and one or more sensors associated with the at least the portion of flooring structure, wherein the one or more sensors sense a user. Further, a controller interfaced with the one or more sensor is operative to detect patterns of the user.

Another embodiment includes an occupant sensing apparatus. The occupant sensing apparatus includes at least a portion of flooring structure, one or more sensors associated with the at least a portion of flooring structure, wherein the one or more sensors sense a user, and a transceiver associated with the at least a portion of flooring structure, wherein the transceiver is operative to communicate with a mobile device of the user.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a plurality of occupant sensing apparatuses, where each occupant sensing apparatus includes a plurality of sensors interfaced with a controller, according to an embodiment.

FIG. 2 shows an occupant sensing apparatus that includes a plurality of sensors and a radio interfaced with a controller, according to an embodiment.

FIG. 3 shows a plurality of building control systems that receive a control signal based at least in part on an occupant sensing system, according to an embodiment.

FIG. 4 shows a building controller that receives occupant sensing and/or occupant identification information from one or more occupant sensing apparatuses, according to an embodiment.

FIG. 5 shows a building controller that receives occupant sensing and/or occupant identification information from one or more occupant flooring and non-flooring sensing apparatuses, according to an embodiment.

FIG. 6 shows an area that includes multiple rooms, wherein non-flooring sensors within each of the multiple rooms and a controller are utilized for detecting occupancy.

FIG. 7 shows a sensor and associated lighting control, according to an embodiment.

FIG. 8 is a flow chart that includes steps of a method of sensing an occupant, according to an embodiment.

FIG. 9 is a flow chart that includes steps of a method of occupancy detection utilizing non-flooring sensors, according to an embodiment.

FIG. 10 is a flow chart that includes steps of a method of occupancy detection utilizing non-flooring sensors, according to another embodiment.

FIG. 11 is a flow chart that includes steps of a method performing the data analytics processing on the motion sensing data to estimate a number of occupants within one or more identified rooms, and a level of certainty of the number of occupants, according to another embodiment.

### DETAILED DESCRIPTION

As shown in the drawings, the described embodiments are embodied in apparatuses, methods, and systems for providing occupant sensing. Further, at least some of the described embodiments include apparatuses, methods, and systems for providing occupant identification. At least some embodiments include sensors of at least a portion of flooring structure. At least some embodiments include non-flooring sensors which can be used in conjunction with the sensors of the at least a portion of flooring structure for occupant sensing, occupant pattern recognition, and/or occupant identification.

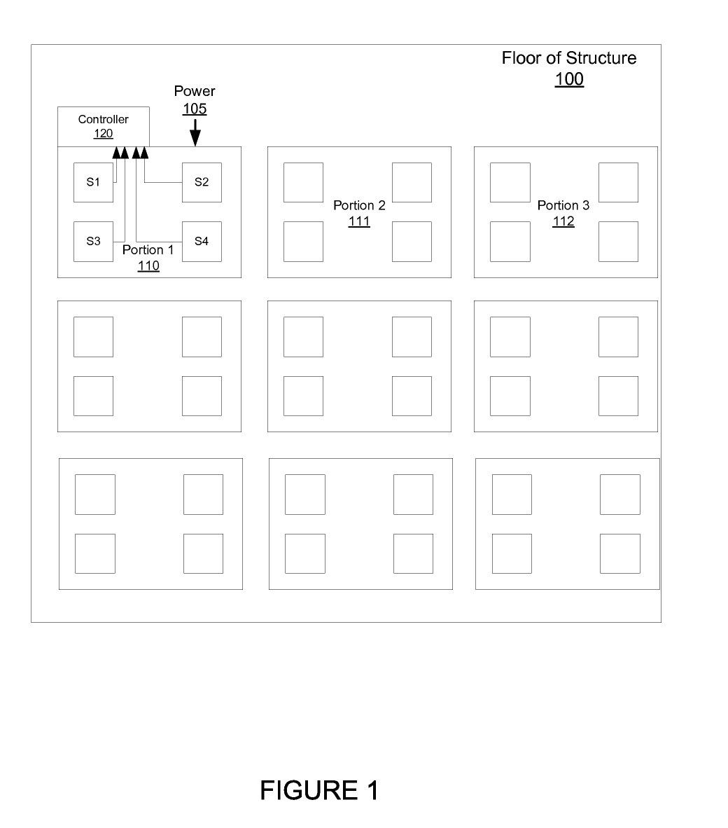

FIG. 1 shows a plurality of occupant sensing apparatuses 110, 111, 112, where each occupant sensing apparatus 110, 111, 112 includes a plurality of sensors S1, S2, S3, S4, interfaced with a controller 120, according to an embodiment. For at least one embodiment, each of the occupant sensing apparatus 110, 111, 112 includes at least a portion of flooring structure. For an embodiment, an external power supply provides electrical power 105 to the occupant sensing apparatus 110.

For an embodiment, the sensors S1, S2, S3, S4 are located or integrated in the flooring of a structure 100. Each of the sensors is able to sense the presence of an occupant. For an embodiment, the sensors S1, S2, S3, S4 sense vibration caused by the user. The vibrations can include, for example, acoustic vibrations, wherein the sensor includes a microphone for picking up low frequency sounds.

For an embodiment, the sensors S1, S2, S3, S4 sense pressure on the at least the portion of the flooring structure caused by occupancy of the user. For an embodiment, the sensors S1, S2, S3, S4 includes accelerometers. While four sensors are shown, it is to be understood that any number of one or more sensors can be used to sensing the presence of an occupant.

For an embodiment, at least one of the sensors includes a radio transceiver, and the sensor is operational to sense communication signals from a device (such as, a smart phone) of the user. Accordingly, the at least one sensors senses the user by sensing the presence of the device of the user. For an embodiment, the radio transceiver of the flooring structure receives wireless signals from the device, and for an embodiment, the radio transceiver demodulates the wireless signal and identifies the device the received wireless signal came from, thereby allowing a controller associated with the radio transceiver to identify the user of the device.

For an embodiment, each of the one or more sensors is interfaced with the controller 120. The controller 120 monitors output signals from the one or more sensors for detecting an occupant. Further, for an embodiment, the controller 120 which is interfaced with one or more of the sensors is operative to detect patterns of the user. For an embodiment, pattern detection includes detecting sequences of sensing by sensors. For example, sequential sensing of signals from sensors S1, S3, S4 may be a first sensed sequence or pattern, and sequential sensing of signals from sensors S3, S4, S1 may be a second sensed sequence or pattern.

For an embodiment, pattern detection includes sensing signals from a particular sensor over time. That is, over time a single sensor generates a sensed signal having a sensed magnitude over time. Sampling of the sensed signal provides a signature that can be matched with a library of stored sensed signals or signatures. As such, for an embodiment, patterns of the sampled signal of a sensor over time are detected by matching the sampled signals with a library of stored sampling patterns. Matching of the sampled sensed signals can further be used to detect activities of a user, or to predict actions and activities of the user.

For an embodiment, detecting a pattern includes both identifying patterns of a sampling of a single sensor over time, and further detecting patterns of sequences of different sensors. That is, each sensor is sampled over time allowing the detection of sub-patterns from sensors, and the sequences of sensing of the sub-patterns of different sensors are sensed.

For at least some embodiments, the detection or sensing of the described patterns is used to detect or sense identities of users, and/or activities of users. Further, for an embodiment, the detected patterns are detected or sensed over time and stored or catalogs. The catalogs of stored patterns can be accessed during future pattern detection for predicting activities of the user or users. That is, by cataloging the sensed patterns and resulting activities of a user or users, future pattern detection can access the cataloged senses patterns and behaviors to predict activities of users. For example, if a particular pattern of behavior, such as, a pattern of an identified user is detected to follow a particular path through a building, at a particular time, and the user nearly always follows such a pattern with a drink of water, future detections of the same pattern can be used to predict that the user will get a drink of water. Predictions are open ended and can include any type of predicted behavior of a user or users.

For an embodiment, the controller is operative to track one or more signals generated by the one or more sensors, and identify activities of the user based on the tracked one or more signals. That is, activities of the occupant can be identified based on the output signals of the one or more sensors. For an embodiment, sequences in which sensors sense occupancy are used to identify activities of the user. For an embodiment, a signature of a single sensed signal, or a signature of more than one sensed signal is used to identify an activity. For an embodiment, the activities of the occupant generate sensor signals have unique characteristics. For example, the occupant falling down, sitting down, walking, jumping, exercising etc., each generate a unique, identifiable sensor signal, that allows the activity of the occupant to be identified. Additionally, activities, such as, working, carrying heavy objects, who a user is accompanied by (e.g. their dog), can be identified.

For an embodiment, the controller is operative to track one or more signals generated by the one or more sensors, and identify conditions of the user based on the tracked one or more signals. For example, is can be possible to identify that gait of the occupancy based on footfalls to discern between different occupants so as to have the control system respond in different ways-for example the light levels might be set higher in response to an older person with failing eyesight, and significantly lower for a teenager with sharp eyesight.

For an embodiment, the controller is operative to track one or more signals generated by the one or more sensors, and identify the user based on the tracked one or more signals. That is, over time the controller can log the behavior of occupants, and learn to identify the occupant based on the behavior. For example, an occupant may demonstrate a unique behavior when working within an office building.

For an embodiment, the one or more sensors associated with the at least the portion of flooring structure are integrated into the at least the portion of flooring structure.

At least some embodiments include multiple types of sensors. For example, simple contact switches technologies can be used that identify deformation (for example, piezo-electric sensors), strain gauges, light pattern changes in light carrying optical fiber and other devices, such as, accelerometers or gyros. Each of the different types of sensors can provide different levels of granularity and specificity. At least some embodiments include marrying at least two different types of sensors to provide elicitation of the different characteristics of the different types of sensors. That is, these embodiments include jointly utilizing multiple types of sensors wherein the sensing characteristics of the different sensors include different sensing characteristics.

For an embodiment, at least a portion of flooring structure comprises a tile, and the one or more sensors associated with the at least the portion of flooring structure are integrated into the tile.

An embodiment includes supplementing control of lighting within a structure associated with the at least a portion of flooring structure based on the detect patterns of the user. For example, the age of an identified occupant can determine the intensity of light of the structure. Further, a type of work or activity (such as, exercising versus watching TV) within the structure can determine the intensity of light within the structure.

An embodiment includes supplementing control of heating or cooling within a structure associated with the at least a portion of flooring structure based on the detect patterns of usage of the user.

An embodiment includes supplementing control of a security system within a structure associated with the at least a portion of flooring structure based on the detect patterns of the user. For example, by detecting and tracking known patterns of occupants, at least some embodiments include detecting unusual (that is, different) patterns. If such unusual patterns are detected, potential security violations can be highlighted. At least some embodiments further include data mining using history not just for one space but looking at patterns across spaces to identify anomalous behavior.

An embodiment includes supplementing control of a health or safety system within a structure associated with the at least a portion of flooring structure based on the detect patterns of the user. For example, at least some embodiments include, for example, fall detection, variation in foot fall patterns, variations in paths taken to detect changes in health and behavior—early onset of health conditions like Alzheimer's, dementia etc.

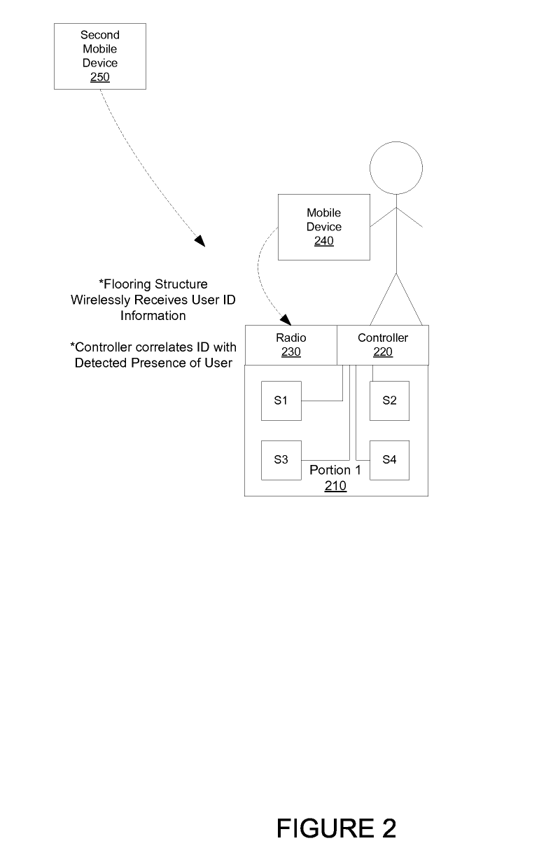

FIG. 2 shows an occupant sensing apparatus (portion 210) that includes a plurality of sensors S1, S2, S3, S4, and a radio 230 interfaced with a controller 220, according to an embodiment. As previously described, the occupant of the structure 100 can be identified by observing behavior of the occupant. However, the embodiment shown in FIG. 2 provides a potentially more powerful method of occupant identification.

Here, the occupant is associated with a mobile device (such as, a smart phone) 240. The mobile device 240 emits a wireless signal which can be received by the radio 230, and used to identify the occupant. For an embodiment, one of the sensors detects that the occupant is present, and the wireless signal received from the mobile device of the occupant identifies the occupant.

To aid in identification of the occupant when other occupants having other mobile devices are present, an embodiment includes the radio 230 and the controller 220 being operative to receive wireless signals from a plurality of mobile devices wherein a wireless signal from each of the plurality of mobile devices includes a mobile device identifier (such as, a MAC, SSID and/or IMEI of the mobile device), and identify the mobile device of the user based on received signal strength of each of the wireless signals received from the plurality of mobile devices, and the mobile device identifier of each of the mobile devices. That is, the closest mobile device will typically belong to the mobile device having the largest signal strength. A second mobile device 250 may also emit a wireless signal that is received by the radio 230. The radio 230 can use the signal strength of the received wireless signals to identify the nearest mobile device which can be assume to belong the user that is sensed by the sensors S1, S2, S3, S4.

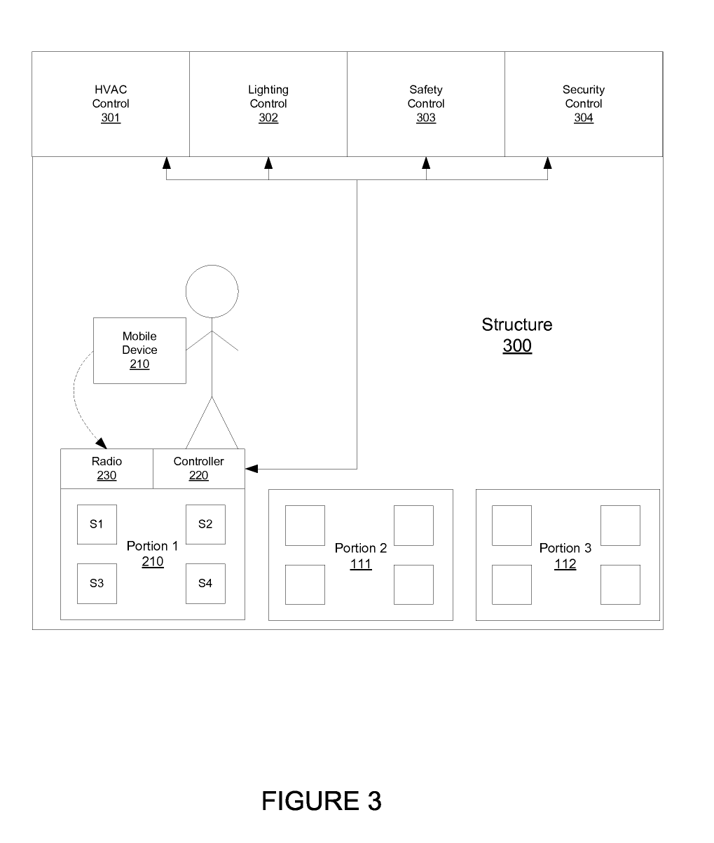

FIG. 3 shows a plurality of building control systems that receive a control signal based at least in part on an occupant sensing system, according to an embodiment. As shown, the sensed occupancy provided by the occupant sensing apparatuses 210, 111, 112 can be used to at least partially control one or more of multiple building control systems. Additionally, or alternatively, the occupant identification systems (the mobile device 210, radio 230 and controller 220) can be used to at least partially control one or more of multiple building control systems.

As shown, a structure 300 includes multiple control systems, such as, an HVAC system 301, a lighting control system 302, a safety control system 303 and a security system 304. These are exemplary systems, and are not intended to be a complete list of possible building control systems. As shown, one or more of the building control systems receives an input from the occupant sensing and/or the occupant identification systems.

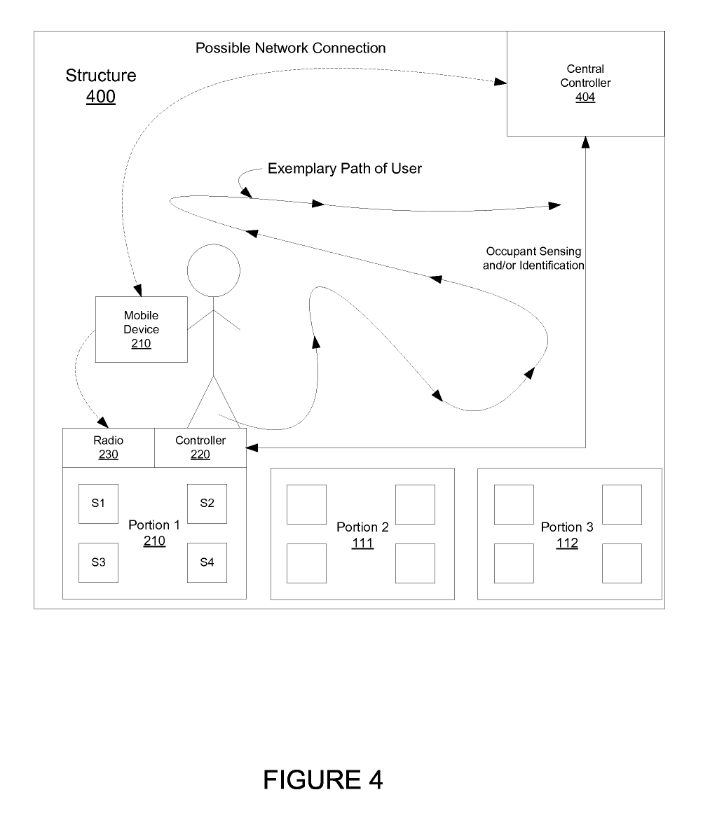

FIG. 4 shows a building controller 404 that receives occupant sensing and/or occupant identification information from one or more occupant sensing apparatuses 210, 111, 112, according to an embodiment. As shown, the occupant follows an identifiable path within a structure 400. For an embodiment, the occupant detection system tracks the motion of the occupant. Based on the tracking, building control can be more intelligently controlled. As previously described, the path of the user can be tracked by identifying sequences of sensors that sense the presence of the user as the user travels through the structure 400.

The specific paths (wherein paths are detected by sequences of sensors sensing signals) taken might be used to anticipate user actions-for example to turn on the bathroom lights, or to warm the water at the tap before the user even arrives at the bathroom. Other actions might be used to raise or lower lights, raise or lower blinds (to watch TV for example), or pre-cool the room in advance of an exercise routine.

For at least some embodiments, the specific paths are identified by tracking a sequence of sensors of one or more of the occupant sensing apparatuses 210, 111, 112. For example, a specific path can be identified by sensing a sequence of S3, S2, S4 of occupant sensing apparatus 210, and the another identifiable sequence of sensors of neighboring occupant sensing apparatus 111. For an embodiment, the identified sequence of sensing by the sensors is compared with a library of user actions to identify the current action of a user. Further, for at least some embodiments, a building control action is taken based on the identified activity of the user, such as, raising or lowering an intensity of light, raising or lowering blinds, and/or raising or lowering a temperature of the structure 400.

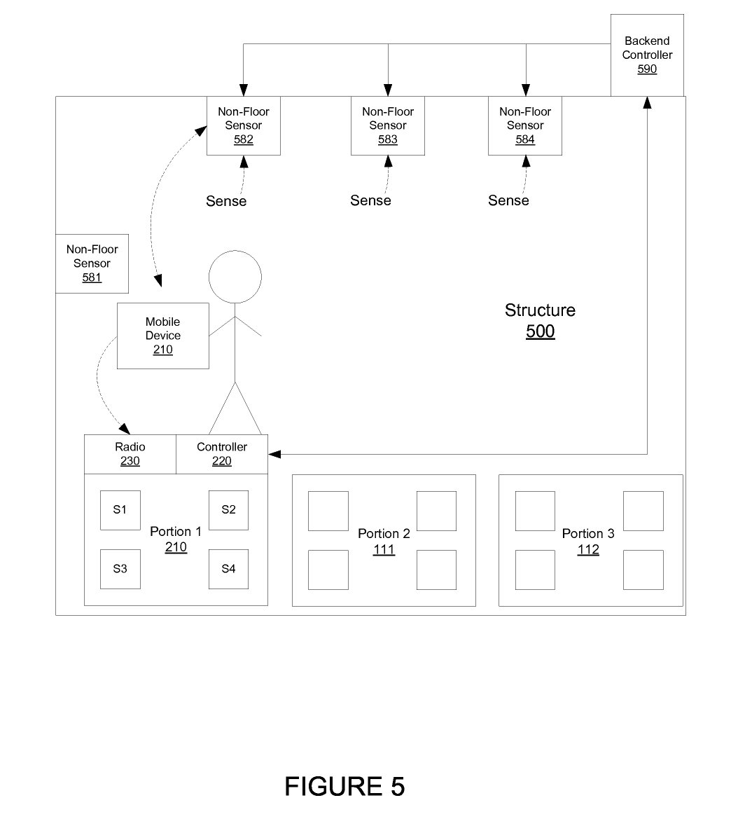

FIG. 5 shows a building controller that receives occupant sensing and/or occupant identification information from one or more occupant flooring and non-flooring sensing apparatuses, according to an embodiment. This embodiment further includes non-flooring sensors 581, 582, 583, 584. The non-flooring sensors can be located anywhere within, for example, a structure 500 that includes the occupant sensing apparatuses 210, 111, 112. As previously stated, for at least one embodiment, each of the occupant sensing apparatus 110, 111, 112 includes at least a portion of flooring structure.

For an embodiment, at least some of the non-flooring sensors 582, 583, 584 are located at or near a ceiling of the structure, and the non-flooring sensors 582, 583, 584 are operative to sense at least one of motion or light within the structure, and automatically adjust an environmental condition within the structure. For example, for an embodiment, one or more of the non-flooring sensors 582, 583, 584 are associated or correspond with a lighting unit within the structure. Further, upon the non-flooring sensors 582, 583, 584 sensing a condition, such as, motion or light, a controller of the sensor or a controller interfaced with the sensor provides control of an associated or corresponding light. Additionally, or alternatively, the sensed condition is used to control other environmental conditions, such as, heating, cooling, and/or air circulation.

The specific paths taken might be used to anticipate user actions—for example to turn on the bathroom lights, or to warm the water at the tap before the user even arrives at the bathroom. Other actions might be used to raise or lower lights, raise or lower blinds (to watch TV for example), or pre-cool the room in advance of an exercise routine. As described, the specific paths can be identified by identifying sequences of sensing by sensors. However, with multiple sensors, additional characteristics can be observed making the detection more powerful. The use of additional types of sensors can provide stronger identification and characterization of the user activities and behavior.

As the sensors (flooring sensors and non-flooring sensors) can each be network connected back to backend server 590, the processes and methods for detecting patterns and behavior of a user or users can be at least partially performed at the backend server 590. The user identification processes previously describes along with the pattern detection processes previously describe provide for powerful identification and pattern recognition of users and a behavior of the users. Further, user safety and monitoring can be performed. For example, the system can watch for safety of people, for example, identifying if elderly people have fallen, whether they have taken their medicines on a routine basis, etc.

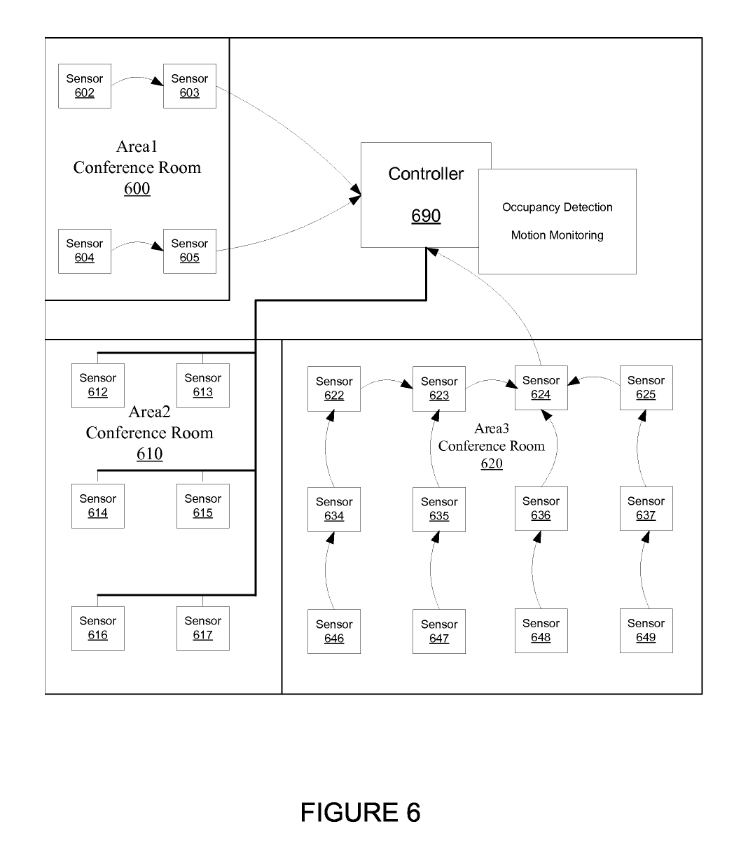

FIG. 6 shows an area that includes multiple rooms, wherein non-flooring sensors within each of the multiple rooms and a controller are utilized for detecting occupancy, according to an embodiment. As shown, occupancy can be detected in an area, such as, a first area 600, a second area 610 and/or a third area 620. The exemplary first area 600 includes sensors 602, 603, 604, 605. The exemplary second area 610 includes sensors 612-617. The exemplary third area 620 includes sensors 622-625, 634-637, 646-649. As shown, a controller 690 receives sensor data from the listed sensors.

For an embodiment, communication links are established between each of the sensors and the controller 690. For an embodiment, the sensors are directly linked to the controller 690. For another embodiment, at least some of the sensors are linked to the controller 690 through other sensors. For an embodiment, the sensors form a wireless mesh network that operates to wirelessly connect (link) each of the sensors to the controller. For an embodiment, one or more of the sensors includes a controller, and a plurality of the sensors is linked to the controller. For an embodiment, one or more of the sensors include motion sensors. For an embodiment, the controller is centrally located, for another embodiment, the controller and associated processing is distributed, for example, across the controllers of multiple sensors.

Regardless of the location or configuration of the controller 690, for an embodiment, the controller 690 is operative to receive sense data from the plurality of sensors, group the data according to identified groupings of the plurality of sensors, and sense occupancy within at least a portion of the area based on data analytics processing of one or more of the groups of sensed data.

For an embodiment, the identified grouping correspond to identified rooms, such as, the exemplary first area 600 (conference room) which includes sensors 602, 603, 604, 604, the exemplary second area 610 (conference room) that includes sensors 612-617, and the exemplary third area 620 (conference room) includes sensors 622-625, 634-637, 646-649.

For an embodiment, based on the data analytics, the controller is operative to sense numbers of occupants within one or more of the groups. For an embodiment, the controller is additionally or alternatively operative to sense motion of the occupants within one or more of the groups based on the data analytics processing of the groups of sensed data, and/or sense motion of the occupants across a plurality of the groups based on the data analytics processing of the groups of sensed data. For an embodiment, the data analytics processing includes pattern recognition processing.

For at least some embodiments, at least a portion of the plurality of sensors includes motion sensors. Further, for an embodiment, sensing the numbers of occupants within one or more of the groups based on the data analytics processing of the groups of sensed data includes the controller being operative to group motion sensing data according to one or more identified rooms within the area, perform the data analytics processing once every sampling period, and perform the data analytics processing on the motion sensing data to determine a number of occupants within the one or more identified rooms, and a level of certainty of the number of occupants.

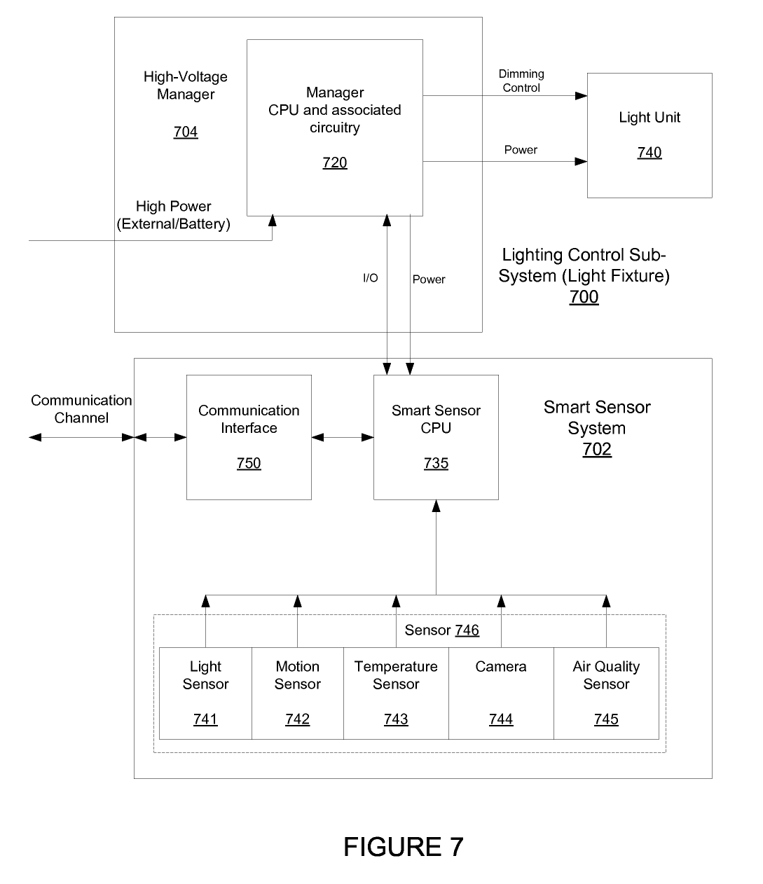

FIG. 7 shows a sensor and associated lighting control, according to an embodiment. A sensor and associated lighting control system 700 includes a smart sensor system 702 that is interfaced with a high-voltage manager 704, which is interfaced with a luminaire 740. The sensor and associated lighting control of FIG. 7 is one exemplary embodiment of the sensors utilized for occupancy detection. Many different sensor embodiments are adapted to utilization of the described embodiments for occupant sensing and motion. For at least some embodiments, sensors that are not directly associated with light control are utilized.

The high-voltage manager 704 includes a controller (manager CPU) 720 that is coupled to the luminaire 740, and to a smart sensor CPU 735 of the smart sensor system 702. As shown, the smart sensor CPU 735 is coupled to a communication interface 750, wherein the communication interface 750 couples the controller to an external device. The smart sensor system 702 additionally includes a sensor 746. As indicated, the sensor 746 can include one or more of a light sensor 741, a motion sensor 742, and temperature sensor 743, and camera 744 and/or an air quality sensor 745. It is to be understood that this is not an exhaustive list of sensors. That is additional or alternate sensors can be utilized for occupancy and motion detection of a structure that utilizes the lighting control sub-system 700. The sensor 746 is coupled to the smart sensor CPU 735, and the sensor 746 generates a sensed input. For at least one embodiment, at least one of the sensors is utilized for communication with the user device.

For an embodiment, the temperature sensor 743 is utilized for occupancy detection. For an embodiment, the temperature sensor 743 is utilized to determine how much and/or how quickly the temperature in the room has increased since the start of, for example, a meeting of occupants. How much the temperate has increased and how quickly the temperature has increased can be correlated with the number of the occupants. All of this is dependent on the dimensions of the room and related to previous occupied periods. For at least some embodiment, estimates and/or knowledge of the number of occupants within a room are used to adjust the HVAC (heating, ventilation and air conditioning) of the room. For an embodiment, the temperature of the room is adjusted based on the estimated number of occupants in the room.

According to at least some embodiments, the controllers (manager CPU 720 and the smart sensor CPU) are operative to control a light output of the luminaire 740 based at least in part on the sensed input, and communicate at least one of state or sensed information to the external device.

For at least some embodiments, the high-voltage manager 704 receives the high-power voltage and generates power control for the luminaire 740, and generates a low-voltage supply for the smart sensor system 702. As suggested, the high-voltage manager 704 and the smart sensor system 702 interact to control a light output of the luminaire 740 based at least in part on the sensed input, and communicate at least one of state or sensed information to the external device. The high-voltage manager 704 and the smart sensor system 702 can also receive state or control information from the external device, which can influence the control of the light output of the luminaire 740. While the manager CPU 720 of the high-voltage manager 704 and the smart sensor CPU 735 of the smart sensor system 702 are shown as separate controllers, it is to be understood that for at least some embodiments the two separate controllers (CPUs) 720, 745 can be implemented as single controller or CPU.

For at least some embodiments, the communication interface 750 provides a wireless link to external devices (for example, the central controller, the user device and/or other lighting sub-systems or devices).

An embodiment of the high-voltage manager 704 of the lighting control sub-system 700 further includes an energy meter (also referred to as a power monitoring unit), which receives the electrical power of the lighting control sub-system 700. The energy meter measures and monitors the power being dissipated by the lighting control sub-system 700. For at least some embodiments, the monitoring of the dissipated power provides for precise monitoring of the dissipated power. Therefore, if the manager CPU 720 receives a demand response (typically, a request from a power company that is received during periods of high power demands) from, for example, a power company, the manager CPU 720 can determine how well the lighting control sub-system 700 is responding to the received demand response. Additionally, or alternatively, the manager CPU 720 can provide indications of how much energy (power) is being used, or saved.

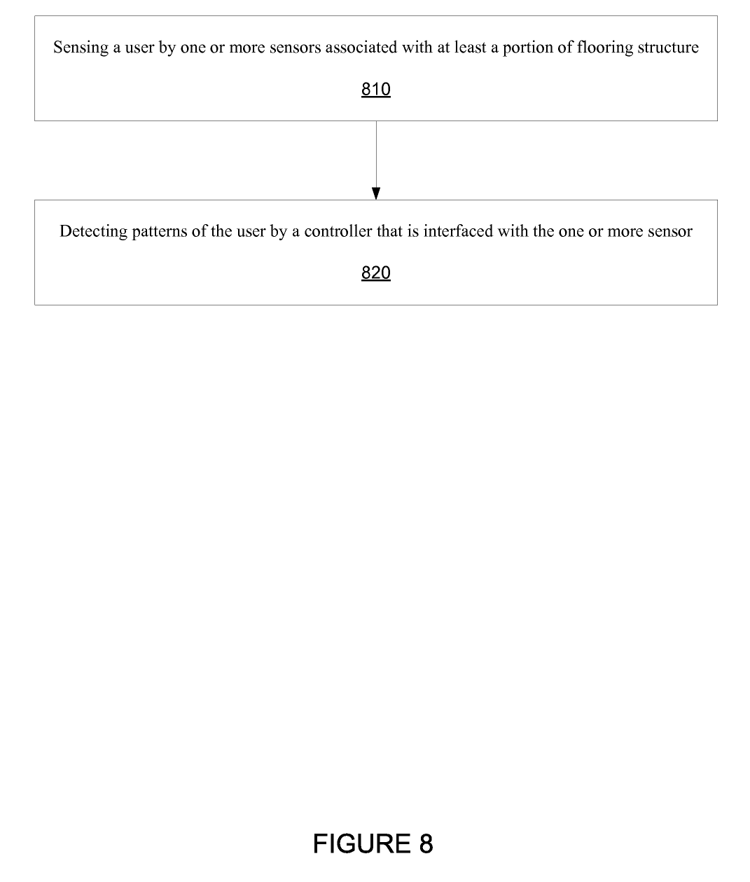

FIG. 8 is a flow chart that includes steps of a method of sensing an occupant, according to an embodiment. A first step 810 includes sensing a user by one or more sensors associated with at least a portion of flooring structure. A second step 820 includes detecting patterns of the user by a controller that is interfaced with the one or more sensor.

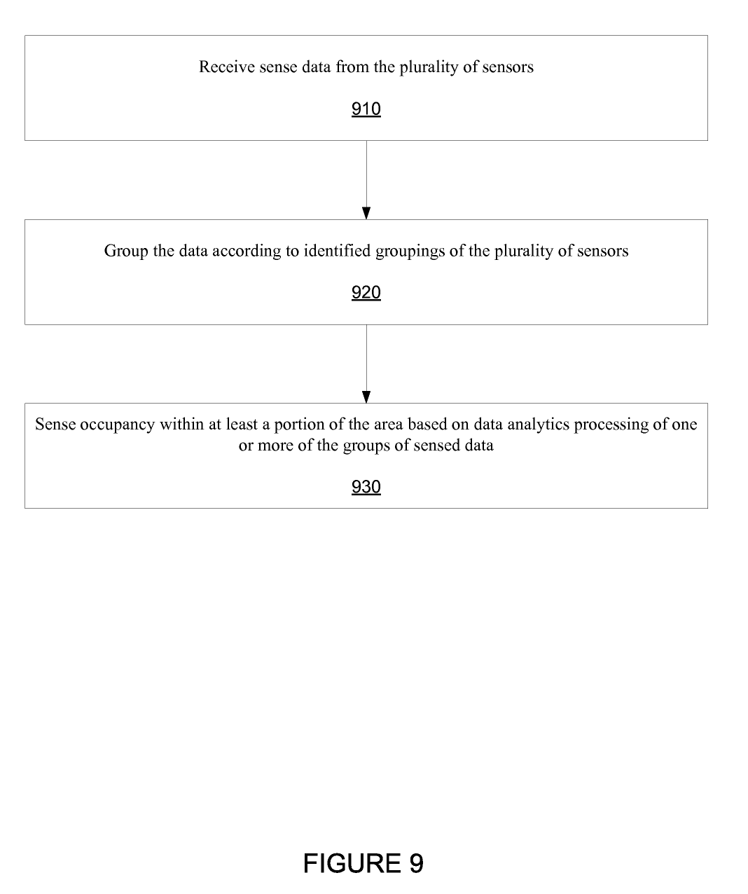

FIG. 9 is a flow chart that includes steps of a method of occupancy detection utilizing non-flooring sensors, according to an embodiment. As previously described, a first step 910 includes receiving sense data from the plurality of sensors, a second step 920 includes grouping the data according to identified groupings of the plurality of sensors, and a third step 930 includes sensing occupancy within at least a portion of the area based on data analytics processing of one or more of the groups of sensed data.

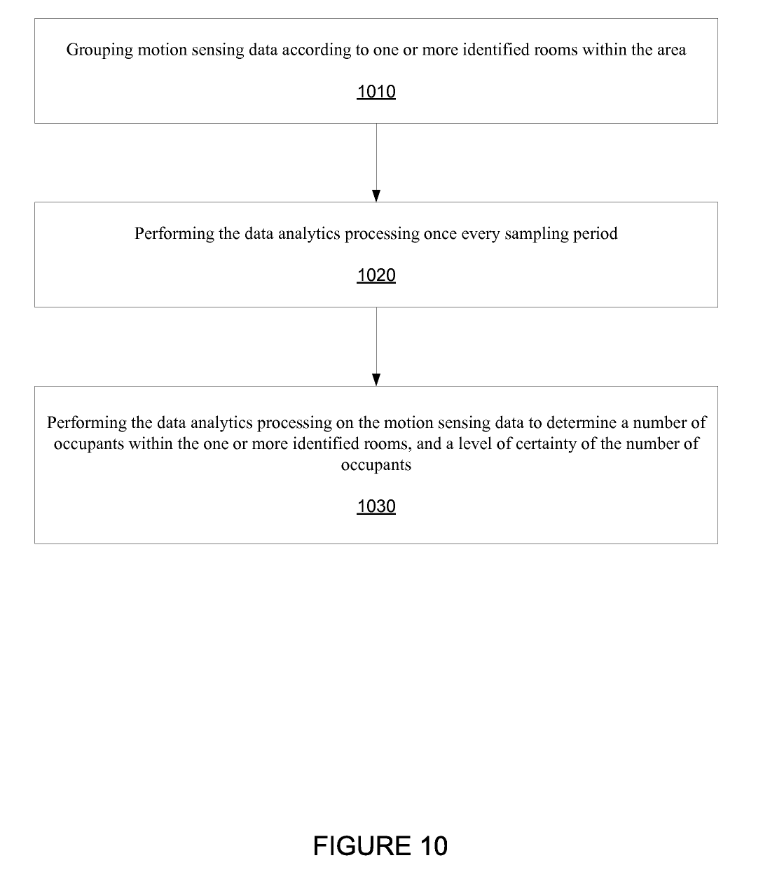

FIG. 10 is a flow chart that includes steps of a method of occupancy detection utilizing non-flooring sensors, according to another embodiment. A first step 1010 includes grouping motion sensing data according to one or more identified rooms within the area. A second step 1020 includes performing the data analytics processing once every sampling period. A third step 1030 includes performing the data analytics processing on the motion sensing data to determine a number of occupants within the one or more identified rooms, and a level of certainty of the number of occupants.

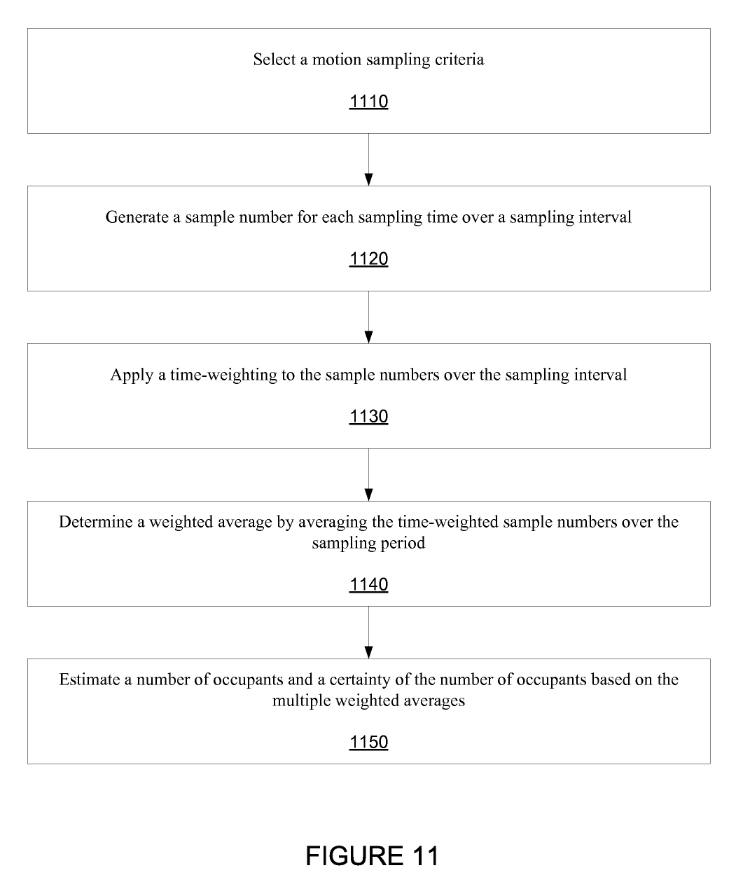

FIG. 11 is a flow chart that includes steps of a method performing the data analytics processing on the motion sensing data to estimate a number of occupants within one or more identified rooms, and a level of certainty of the number of occupants, according to another embodiment. For an area or identified room within a structure, a set number of sensors (such as motion sensors) are located. A first step 1110 includes selecting a motion sampling criteria. A first exemplary motion sampling criteria includes generating a sampling number based on sensing how many sensors of a plurality of sensors of the identified room sense motion greater than a threshold at each sampling time of the sampling interval. That is, if a motion sensor generates a sense signal having a magnitude greater than a threshold, it is determined that the motion sensor actually sensed motion. The sample number is a generated number that will be processed for determination of the number of occupants within the identified room. A sampling number is generated at each sampling time over the sampling interval. A second exemplary motion sampling criteria includes generating the sampling number based on sensing a percentage of time that greater than a threshold number of the sensors of the plurality of sensors of the identified room sense motion greater than a threshold at each sampling time of the sampling interval.

For an embodiment, the motion sampling criteria includes determining the sampling number based on sensing how many sensors of a plurality of sensors of the one or more identified rooms sense motion greater than a threshold at each sampling time of the sampling interval, and selecting a quadratic weighting to apply to the sample numbers over the sampling interval.

For an embodiment, the motion sampling criteria includes determining the sampling number based on sensing a percentage of time that greater than a threshold number of the sensors of a plurality of sensors of the one or more identified rooms sense motion greater than a threshold at each sampling time of the sampling interval, and selecting a linear weighting to apply to the sample numbers over the sampling interval.

For an embodiment, the motion sampling criteria includes determining the sampling number based on sensing a percentage of time that less than a threshold number of the sensors of a plurality of sensors of the one or more identified rooms sense motion greater than a threshold at each sampling time of the sampling interval, and selecting a linear weighting to apply to the sample numbers over the sampling interval.

For each motion sampling criteria, at embodiment includes a step 1120 that includes generating a sample number for each sampling time over a sampling interval. Next, a step 1130 includes applying a time-weighting to the sample numbers over the sampling interval. Next, a step 1140 includes determining a weighted average by averaging the time-weighted sample numbers over the sampling period. Finally, a step 1150 includes estimating a number of occupants and a certainty of the number of occupants based the weighted average.

Although specific embodiments have been described and illustrated, the described embodiments are not to be limited to the specific forms or arrangements of parts so described and illustrated. The embodiments are limited only by the appended claims.

What is claimed:

1. An occupant sensing apparatus, comprising:
at least a portion of flooring structure; and
one or more sensors associated with the at least the portion of flooring structure, wherein the one or more sensors sense a user; wherein
a controller interfaced with the one or more sensor is operative to detect patterns of the user.

2. The occupant sensing apparatus, of claim 1, wherein the one or more sensors sense vibration caused by the user.

3. The occupant sensing apparatus, of claim 1, wherein the one or more sensors sense pressure on the at least the portion of the flooring structure caused by occupancy of the user.

4. The occupant sensing apparatus, of claim 1, wherein the controller is operative to track one or more signals generated by the one or more sensors, and identify activities of the user based on the tracked one or more signals.

5. The occupant sensing apparatus, of claim 1, wherein the controller is operative to track one or more signals generated by the one or more sensors, and identify conditions of the user based on the tracked one or more signals.

6. The occupant sensing apparatus, of claim 1, wherein the controller is operative to track one or more signals generated by the one or more sensors, and identify the user based on the tracked one or more signals.

7. The occupant sensing apparatus, of claim 1, wherein the one or more sensors associated with the at least the portion of flooring structure are integrated into the at least the portion of flooring structure.

8. The occupant sensing apparatus, of claim 1, wherein at least a portion of flooring structure comprises a tile, and the one or more sensors associated with the at least the portion of flooring structure are integrated into the tile.

9. The occupant sensing apparatus, of claim 1, further comprising at least supplementing control of lighting within a structure associated with the at least a portion of flooring structure based on the detect patterns of the user.

10. The occupant sensing apparatus, of claim 1, further comprising at least supplementing control of heating or cooling within a structure associated with the at least a portion of flooring structure based on the detect patterns of usage of the user.

11. The occupant sensing apparatus, of claim 1, further comprising at least supplementing control of a security system within a structure associated with the at least a portion of flooring structure based on the detect patterns of the user.

12. The occupant sensing apparatus, of claim 1, further comprising at least supplementing control of a health or safety system within a structure associated with the at least a portion of flooring structure based on the detect patterns of the user.

13. The occupant sensing apparatus, of claim 1, further comprising a transceiver associated with the at least a portion of flooring structure, wherein the transceiver is operative to communicate with a mobile device of the user.

14. The occupant sensing apparatus of claim 13, wherein the transceiver is further operative to receive wireless signals from the mobile device, and identify the user from the received wireless signals.

15. The occupant sensing apparatus of claim 13, wherein the transceiver is further operative to receive wireless signals from a plurality of mobile devices wherein a wireless signal from each of the plurality of mobile devices includes a mobile device identifier, and identify the mobile device of the user based on received signal strength of each of the wireless signals received from the plurality of mobile devices, and the mobile device identifier of each of the mobile devices.

16. The occupant sensing apparatus of claim 1, wherein the occupancy sensing apparatus is included within an occupancy detection system, and the occupancy detection system further includes:
a plurality of non-flooring sensors located within an area, wherein the at least the portion of flooring structure is located within the area;
communication links between each of the non-flooring sensors and a controller, wherein the controller is operative to:
receive sense data from the plurality of non-flooring sensors;
group the data according to identified groupings of the plurality of non-flooring sensors;
sense occupancy within at least a portion of the area based on data analytics processing of one or more of the groups of sensed data.

17. A method of sensing an occupant, comprising:
sensing a user by one or more sensors associated with at least a portion of flooring structure; and
detecting patterns of the user by a controller that is interfaced with the one or more sensor.

18. The method of claim 17, further comprising tracking one or more signals generated by the one or more sensors, and identifying activities of the user based on the tracked one or more signals.

19. The method of claim 17, further comprising tracking one or more signals generated by the one or more sensors, and identifying conditions of the user based on the tracked one or more signals.

20. The method of claim 17, further comprising tracking one or more signals generated by the one or more sensors, and identifying the user based on the tracked one or more signals.
